(19) United States
(12) Patent Application Publication
(10) Pub. No.: US 2026/0240207 A1
(43) Pub. Date: Aug. 20, 2026

(54) METHOD FOR PREPARING DATE FLAKES

(71) Applicant: Sultan Qaboos University, Al Khodh (OM)

(72) Inventors: Nasser Abdullah AL-HABSI, Al Khodh (OM); Yahya Salim Ali AL AMRANI, Al Khodh (OM); MD Shafiur RAHMAN, Al Khodh (OM)

(21) Appl. No.: 19/057,830

(22) Filed: Feb. 19, 2025

(51) Int. Cl. A23L 19/00; A23P 30/40

(52) U.S. Cl. CPC A23L 19/01; A23P 30/40

(57) ABSTRACT

A method for preparing date flakes can include obtaining dates including date flesh and date pits; separating the date pits from the date flesh; reducing the separated date flesh to a date flesh powder and the date pits to a date pit powder; forming a mixture including the date flesh powder, the date pit powder, and water; drying the mixture to obtain a dried date product; and reducing a size of the dried date product to provide a plurality of date flakes. In some embodiments the mixture may be foamed prior to drying.

### BACKGROUND

### 1. Field

The present disclosure relates to a method for preparing date flakes and, particularly, to a method for preparing date flakes from date pits and date flesh.

### 2. Description of the Related Art

Date palm is one of the most important crops in Oman. There are over 250 cultivars. The date palm cultivar, Mabsli, is considered to be one of the top five producing date palm cultivars in Oman, with the production of 28 thousand tons in 2020. Mabsli dates do not have a high market value in Oman. As such, Mabsli dates are generally exported at a low price and used for different high value added products when exported overseas.

Developing desirable date products from dates would be especially useful for countries with high levels of date production. This can provide valorization of a low value raw material and be profitable to these countries.

Thus, a new method for preparing date flakes solving the aforementioned problems is desired.

### SUMMARY

The present subject matter relates to a method for preparing date flakes for consumption as a breakfast cereal or as a healthy snack. The date flakes can be derived from date pits and date flesh. The date flakes can have a high content of fiber, bioactive polyphenols, and natural antioxidants. Additionally, the date flakes can have desired sensory attributes, such as crunchiness and an extended bowl life. As such, the date flakes can provide a healthy food option, such as a breakfast cereal or a dried fruit snack. The date flesh and date pits can be obtained from Mabsli dates. Unlike conventional cereals, the date flakes can be prepared by a method that does not include extrusion, thereby minimizing processing costs.

According to an embodiment, a method for preparing date flakes can include obtaining dates including date flesh and date pits; separating the date pits from the date-flesh, reducing the separated date flesh into a date flesh powder and the date pits to a date pit powder; forming a mixture including the date flesh powder; the date pit powder, and water; drying the mixture to obtain a dried date product; and reducing a size of the dried date product to provide a plurality of date flakes.

These and other features of the present subject matter will become readily apparent upon further review of the following specification.

### BRIEF DESCRIPTION OF THE DRAWINGS

FIG. 1 is a schematic diagram showing powder preparation according to the present teachings.

FIG. 2 is a schematic diagram showing date flakes processing steps according to the present technique.

### DETAILED DESCRIPTION OF THE PREFERRED EMBODIMENTS

The following definitions are provided for the purpose of understanding the present subject matter and for construing the appended patent claims.

### Definitions

Throughout the application, where compositions are described as having, including, or comprising specific components, or where processes are described as having, including, or comprising specific process steps, it is contemplated that compositions of the present teachings can also consist essentially of, or consist of, the recited components, and that the processes of the present teachings can also consist essentially of, or consist of, the recited process steps.

It is noted that, as used in this specification and the appended claims, the singular forms “a”, “an”, and “the” include plural references unless the context clearly dictates otherwise.

In the application, where an element or component is said to be included in and/or selected from a list of recited elements or components, it should be understood that the element or component can be any one of the recited elements or components, or the element or component can be selected from a group consisting of two or more of the recited elements or components. Further, it should be understood that elements and/or features of a composition or a method described herein can be combined in a variety of ways without departing from the spirit and scope of the present teachings, whether explicit or implicit herein.

The use of the terms “include,” “includes”, “including,” “have,” “has,” or “having” should be generally understood as open-ended and non-limiting unless specifically stated otherwise.

The use of the singular herein includes the plural (and vice versa) unless specifically stated otherwise. In addition, where the use of the term “about” is before a quantitative value, the present teachings also include the specific quantitative value itself, unless specifically stated otherwise. As used herein, the term “about” refers to a ±10% variation from the nominal value unless otherwise indicated or inferred.

The term “optional” or “optionally” means that the subsequently described event or circumstance may or may not occur, and that the description includes instances where said event or circumstance occurs and instances in which it does not.

Unless defined otherwise, all technical and scientific terms used herein have the same meaning as commonly understood to one of ordinary skill in the art to which the presently described subject matter pertains.

Where a range of values is provided, for example, concentration ranges, percentage ranges, or ratio ranges, it is understood that each intervening value, to the tenth of the unit of the lower limit, unless the context clearly dictates otherwise, between the upper and lower limit of that range and any other stated or intervening value in that stated range, is encompassed within the described subject matter. The upper and lower limits of these smaller ranges may independently be included in the smaller ranges, and such embodiments are also encompassed within the described subject matter, subject to any specifically excluded limit in the stated range. Where the stated range includes one or both of the limits, ranges excluding either or both of those included limits are also included in the described subject matter.

Throughout the application, descriptions of various embodiments use “comprising” language. However, it will be understood by one of skill in the art, that in some specific instances, an embodiment can alternatively be described using the language “consisting essentially of” or “consisting of”.

For purposes of better understanding the present teachings and in no way limiting the scope of the teachings, unless otherwise indicated, all numbers expressing quantities, percentages or proportions, and other numerical values used in the specification and claims, are to be understood as being modified in all instances by the term “about”. Accordingly, unless indicated to the contrary, the numerical parameters set forth in the following specification and attached claims are approximations that may vary depending upon the desired properties sought to be obtained. At the very least, each numerical parameter should at least be construed in light of the number of reported significant digits and by applying ordinary rounding techniques.

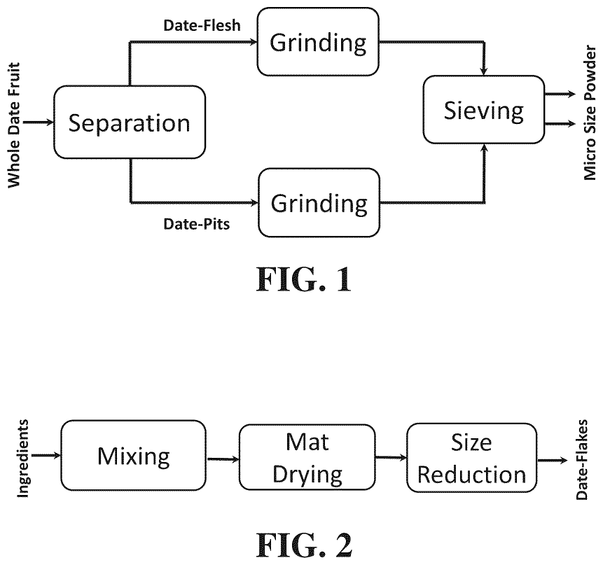

The present subject matter relates to a method for preparing date flakes. In an embodiment, the method can include obtaining dates including date flesh and date pits; separating the date pits from the date flesh; reducing the separated date flesh to a date flesh powder and the date pits to a date pit powder; forming a mixture including the date flesh powder and the date pit powder; drying the mixture to obtain a dried date product; and reducing a size of the dried date product to provide a plurality of date flakes, as shown in FIGS. 1-2. In an embodiment, the date pits and date flakes can be ground and passed through a 500 μm sieve size to provide the powder.

In an embodiment, the mixture can be formed by combining the date flesh powder, the date pit powder, water, and salt. In an embodiment, a ratio of date flesh powder to date pit powder in the mixture can be 95:5. In an embodiment, the mixture can be dried at a temperature ranging from about 100° C. to about 200° C., e.g., about 150° C. for about 10 minutes to about 20 minutes, e.g., about 15 minutes. In an embodiment, the dried date product can be prepared by mat drying of the date flesh and date pits mixture.

As used herein, “mat drying” is an over drying method that transforms the raw material into a foam and then oven drying the foam. First all ingredients were blended to make foam first and then overdried so that porous structures could form.

According to an embodiment, an exemplary method for preparing the date flakes can include combining about 128 grams of a date powder including date flesh powder and date pit powder with about 200 grams of water, and about 1.5 grams of salt. The resulting mixture is then foamed and spread on a baking paper and dried in a baking oven. The optimum drying temperature can be about 150° C. and the optimum drying time can be about 15 minutes.

In an embodiment, the dates can be from a date palm cultivar that requires heat processing prior to consumption. In an embodiment, the dates can be obtained from Oman. In an embodiment, the dates can be Mabsli dates. Mabsli dates are an abundant low value raw material in Oman that are typically exported to other countries for consumption. Thus, the method for preparing date flakes from Mabsli dates can valorize this otherwise low value raw material or unutilized.

The date flakes prepared according to the method described herein can be used as a healthy breakfast cereal. In an embodiment, the date flakes can have a high content of fiber, bioactive polyphenols, and natural antioxidants.

It should be understood that extrusion technology is not required for preparing date flakes according to the method of the present teachings. Conventional breakfast flakes are typically prepared from grains, e. g, wheat, corn, and/or oat, using extrusion technology. Extrusion technology, however, is not suitable for preparing date flakes because of the high sugar content in the date flesh. For example, extrusion technology is not suitable for providing puffed date flakes. The high level of sugars in the date flesh melts inside the extrusion machine, causing blockage of the machine's nozzles. In addition, extrusion technology is costly in terms of energy consumption and capital cost.

The following examples illustrate the present teachings.

### EXAMPLES

### Example 1

### Preparation of Date Flakes

Date flesh and date pits were ground in a heavy-duty rotating blade grinder and passed through a 500 μm size sieve to provide a powder. A mixture was prepared including date flesh powder and date pit powder at a ratio of 95:5. About 128 grams of the mixture of date flesh powder and date pit powder was combined with 200 grams of water and 1.5 grams of salt. The resulting mixture was transformed into foam by a blender and then spread on a baking paper and dried in a baking oven at 150° C. for 15 minutes.

It is to be understood that the method for preparing date flakes is not limited to the specific embodiments described above, but encompasses any and all embodiments within the scope of the generic language of the following claims enabled by the embodiments described herein, or otherwise shown in the drawings or described above in terms sufficient to enable one of ordinary skill in the art to make and use the claimed subject matter.

1. A method for preparing date flakes, comprising:
obtaining dates from a date palm plant, the dates including date flesh and date pits;
separating the date pits from the date flesh;
reducing the separated date flesh into date flesh powder and the date pits to a date pit powder;
forming a mixture consisting of the date flesh powder, the date pit powder, and water;
blending the mixture;
mat-drying the blended mixture to obtain a dried date product; and
reducing a size of the dried date product to provide a plurality of porous date flakes.

2. (canceled)

3. (canceled)

4. The method of claim 1, wherein the foamed mixture is dried at a temperature ranging from about 100° C. to about 200° C.

5. The method of claim 4, wherein the foamed mixture is dried for about 10 minutes to about 20 minutes.

6. A method for preparing date flakes, comprising:
obtaining dates including date flesh and date pits;
separating the date pits from the date flesh;
reducing the separated date flesh and date pits to form a date flesh powder and a date pit powder;
forming a mixture consisting of the date flesh powder, the date pit powder, water, and salt;
mat drying the mixture to obtain a dried date product; and
reducing a size of the dried date product to provide a plurality of porous date flakes, wherein a ratio of the date flesh powder to the date-pit powder in the mixture is about 95:5.

7. The method of claim 6, wherein the mixture is dried at a temperature ranging from about 100° C. to about 200° C.

8. The method of claim 7, wherein the mixture is dried for about 10 minutes to about 20 minutes.

9. A method for preparing date flakes, comprising:
obtaining dates from a date palm plant, the dates including date flesh and date pits;
separating the date pits from the date flesh;
reducing the separated date flesh into date flesh powder and the date pits to a date pit powder;
forming a mixture consisting of the date flesh powder, the date pit powder, salt, and water;
blending the mixture;
mat-drying the blended mixture to obtain a dried date product; and
reducing a size of the dried date product to provide a plurality of porous date flakes.
